(19) United States
(12) Patent Application Publication
(10) Pub. No.: US 2017/0327281 A1
(43) Pub. Date: Nov. 16, 2017

(54) SELF-VENTING CONTAINER WITH USER-CONTROLLED VALVE

(71) Applicant: Shawn Cross, Rio Rancho, NM (US)

(72) Inventor: Shawn Cross, Rio Rancho, NM (US)

(21) Appl. No.: 15/273,365

(22) Filed: Sep. 22, 2016

Related U.S. Application Data
(60) Provisional application No. 62/334,401, filed on May 10, 2016.
(60) Provisional application No. 62/365,265, filed on Jul. 21, 2016.
(60) Provisional application No. 62/365,539, filed on Jul. 22, 2016.

(51) Int. Cl. B65D 47/06; B67D 7/00; B65D 47/32; B65D 47/24; B67D 7/36; B65D 25/28; B67D 7/04

(52) U.S. Cl. CPC B65D 47/066; B67D 7/36; B67D 7/005; B65D 25/2882; B65D 47/32; B65D 47/241; B67D 7/04

(57) ABSTRACT

A liquid container, meeting all federal, state and local regulations, comprising a vessel with an opening and a self-venting spout which is mounted to the vessel in a manner allowing the spout, from a stowed position, to rotate into its operational position and coupling to the opening with a coupler. Both open ends of the spout are automatically covered when stowed. A valve assembly at the opening of the vessel is operated externally by a trigger located near the underside of the primary handle. The valve assembly controls flow of liquid out of the vessel and through the self-venting spout. Venting of the vessel is allowed through a series of channels, respectively comprising an interior channel within the spout, an intake port, and an intake channel leading to the rear of the vessel above the liquid line. The vessel opening is covered by a lid mounted to the vessel that rotates into operational or stowed position and is sealed by the coupler.

### CROSS-REFERENCE TO RELATED APPLICATIONS

This application claims priority to and the benefit of U.S. Provisional Patent Application No. 62/334,401, entitled “Self Venting Container, Featuring User Controlled Valve”, filed on May 10, 2016; this application also claims priority to and the benefit of U.S. Provisional Patent Application No. 62/365,265, entitled “Self Venting Container, Featuring User Controlled Valve”, filed on Jul. 21, 2016; this application also claims priority and the benefit of U.S. Provisional Patent Application No. 62/365,539, entitled “Self Venting Container, Featuring User Controlled Valve”, filed on Jul. 22, 2016 and the claims (if any) and specifications thereof are incorporated herein by reference.

### BACKGROUND OF THE INVENTION

### Field of the Invention (Technical Field)

Embodiments of the present invention relate to a self-venting liquid container. More particularly, embodiments of the present invention relate to a self-venting liquid container which can be filled directly through a discharge valve.

### Description of Related Art

Self-venting containers, particularly fuel containers, have been known for some time. Because of the numerous governmental regulations relating to fuel containers, such containers are required to have features which typically make their use cumbersome. Most fuel containers, for example, have a discharge valve which prevents the escape of the contents of the container unless a user activates a mechanism. Often, the activation mechanism is difficult to use when attempting to hold steady a container with liquid disposed therein and simultaneously pour the contents from the container into a desired location—such as a fuel tank. The known valves and activation mechanisms are also typically undersized, thus resulting in a very slow flow rate when discharging the container. Further, because such containers are often intended to be reusable, a user must somehow avoid the various valves of the container in order to refill it. The most common way for a user to refill such a container is to either unscrew and remove the valve assembly to expose the open container, or a second opening, having a closable top, must be provided for refilling purposes. Both of these configurations are less than desirable because they either require a user to perform several more steps or they increase the cost of construction of the container and thereby result in a more expensive container.

There is thus a present need for a self-venting container that is quick and easy to use, has an acceptable flow rate, contains all required safety features, includes all parts and pieces that remain attached to the container, include a self-vented spout that can stow on an outside of the container, can automatically cover a spout tip and base upon stowing, include a lid or spout locking and unlocking mechanism, which can optionally include a coupler that is easy and effective to use, and has a trigger-safety mechanism to prevent accidental activation of the discharge trigger.

### BRIEF SUMMARY OF EMBODIMENTS OF THE PRESENT INVENTION

An embodiment of the present invention relates to a portable liquid delivery apparatus having a liquid storage vessel, the liquid storage vessel having only one opening, a liquid discharge valve, and a check valve, the check valve forming a portion of the discharge valve. The opening can be at or near a top of the container. The check valve preferably has dimensions sufficiently large to permit a standard fuel pump nozzle to pass through it. The portable liquid delivery apparatus can also have an vent valve. The vent valve can be communicably coupled to the liquid discharge valve—most preferably via a connection that provides mechanical advantage. The portable liquid delivery apparatus can include a spout, which can be hingedly connected such that it can rotate so that an inlet of the spout can rotate with respect to the storage vessel to align with the opening of the liquid storage vessel. Optionally, a spout inlet cover can be provided which can be hingedly connected to the liquid storage vessel. A handle can also be provided and the handle can have an opening with dimensions that create an interference fit with an outside of the spout.

An embodiment of the present invention also relates to a portable liquid delivery apparatus having a liquid storage vessel; a liquid discharge valve; and a vent valve, the vent valve communicably coupled to the liquid discharge valve via a connection that provides mechanical advantage. The liquid storage vessel can optionally have only one opening. A lid, which can include a cap or cover can be rotatably coupled to the portable liquid delivery apparatus.

An embodiment of the present invention also relates to a portable fuel container having a liquid storage vessel and a liquid discharge valve. The liquid discharge valve can be configured to receive a fuel pump nozzle by allowing an end portion of the fuel pump nozzle to pass directly through the liquid discharge valve for filling the portable fuel container with fuel.

An embodiment of the present invention also relates to a portable fuel container having a liquid storage vessel with only one opening for both dispensing liquid from the fuel container and for filling the fuel container from a standard fuel pump nozzle and a liquid discharge valve disposed in fluid communication with the one opening, such that the liquid storage vessel can be filled from the standard fuel pump nozzle without requiring a user to remove the liquid discharge valve from the flow path of the fuel. Optionally, the only one opening can include an intake inlet. Optionally, a check valve can be disposed in fluid communication with the liquid discharge valve.

An embodiment of the present invention also relates to a portable liquid storage vessel having a liquid storage vessel with an opening, a neck extending from the opening, and a coupler disposed about the neck, the coupler comprising a rim on its front face, the rim comprising a plurality of tab-receiving openings formed therein.

An embodiment of the present invention relates to a liquid container comprising an opening and a primary handle on top of a vessel. A self-venting spout is preferably mounted to the vessel in a manner allowing the spout to rotate into place from a stowed position, preferably nested in a depression of the primary handle, into the operational position and coupling to the opening with a coupler. The self-venting spout can stow externally of the vessel and easily rotate into place for operation. Tip and base of the spout can be automatically covered when stowed. A retainer/dust cover is preferably built into the primary handle to cover the tip and keep the spout from falling out of its stowed position. The base of the spout preferably interacts with a dust cover that is levered against the base when stowing the spout. The coupler allows for quick and easy connection and disconnection of the spout, preferably with a ¼ turn clockwise and/or counterclockwise. A valve assembly at or near the opening of container is operated externally by a trigger near the underside of primary handle after easily releasing a safety latch which prevents incidental operation of the trigger. This allows for ease of operation of the present invention while being able to maintain a grasp on the primary handle and the secondary handle. The valve assembly aligns with the spout and controls flow of liquid out of container through the spout and allows air to enter the container through an intake channel leading to the rear of the container above the liquid line, allowing liquid to flow freely without the “glug-glug” effect. In one embodiment, a valve can be mounted to the discharge valve in order to easily penetrate a void in the discharge valve for filling the container.

In one embodiment, all respective external parts and pieces of the apparatus are mounted attached to the container, either directly or indirectly. This keeps all of the various components together so that none of them become lost or otherwise separated from the rest of the components. Although some embodiments of the invention are preferably hinged, it is understood that other connection types can be used in place of a hinge, including but not limited to a tether, a track and/or sliding configuration.

An embodiment of the present invention preferably provides self-venting spout that is flexible for ease of manipulation for use, while other spill-proof containers have rigid self-venting spouts. The spout preferably stows externally of container as opposed to others which stow inside of container and thus causes a user to get residual liquid on their hands when he or she pulls it out of the container and attempts to attach it. The spout preferably has a flange for ease of coupling to the container via a coupler, most preferably allowing for less than one full turn to tighten, while other spouts are connected with a threaded coupler needing about two full turns or more to tighten. The spout preferably aligns with a valve assembly that allows liquid to exit container while air and/or vapors within the receiving container replaces the dispensed liquid, thus reducing emissions into the atmosphere.

In one embodiment, there is preferably a valve assembly having a plurality of valves which are communicably coupled and operable with a single action, thus allowing liquid to dispense through a discharge valve while venting of the vessel occurs through a vent valve, unlike known containers that have a valve system housed within a self-venting spout and which thus force a user to attempt to manipulate the spout to actuate a valve system. In one embodiment, the valve assembly is mounted to the container, thus allowing for a spill-proof container at all times. The valve assembly can include a check valve that allows the container to be filled from an opening of the container while maintaining a spill-proof system, unlike known containers that create a potential hazard for spilling by requiring a user to remove a spout and/or cap for filling. In one embodiment, the valve assembly can include an intake channel that terminates above a surface of the liquid, thus allowing air to enter container without impedance and eliminating the “glug-glug” effect. This is also unlike known containers that merely provide a self-venting channel in the spout only.

An embodiment of the present invention also provides a trigger that is mounted external of the container for operation of the valve assembly, thus allowing for maximum handling of container and comfortable operation of the trigger with as little as a single finger—unlike known containers that have an actuation by manipulation of the spout or an awkward thumb operated trigger.

Objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIGS. 1, 2, and 3 are drawings which illustrate an external elevated perspective view of an embodiment of the present invention wherein the spout is in a stowed position (FIG. 1), is in a transitory position between a stowed configuration and an in-use configuration (FIG. 2), and wherein the spout is positioned for use (FIG. 3);

FIGS. 4 and 5 are exploded-view drawings which illustrate various components of the valves of an embodiment of the present invention;

FIG. 6 is a sectional, exploded-view drawing, which illustrate components of the valves according to an embodiment of the present invention;

FIGS. 7, 8, and 9 are cross-sectional side-view drawings which respectively illustrate a valve assembly, a valve assembly with a trigger mechanism and a rotatable spout, and a self-venting container according to an embodiment of the present invention;

FIGS. 10 and 11 are sectional view drawing that illustrate an embodiment of the present invention wherein a check valve is respectively in an open and a closed configuration; and

FIGS. 12 and 13 are drawings which illustrate a spout with retention tabs around its proximal opening and with arms that connect a portion of a hinge to the spout.

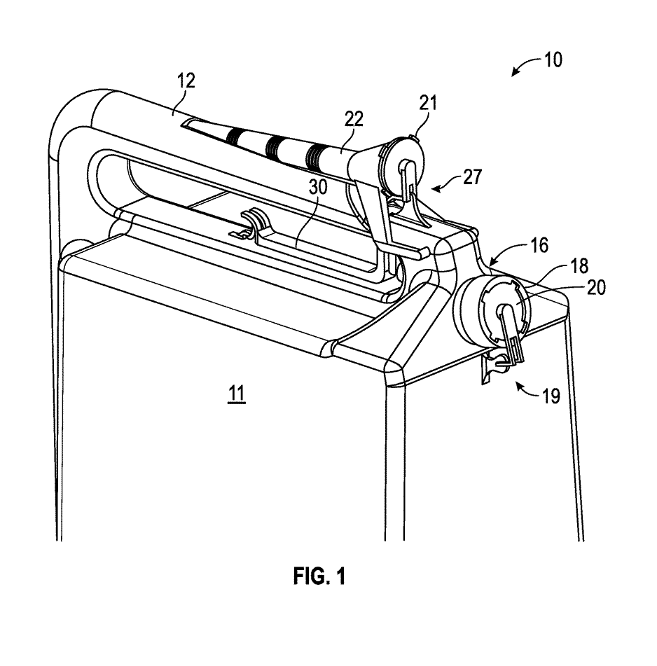

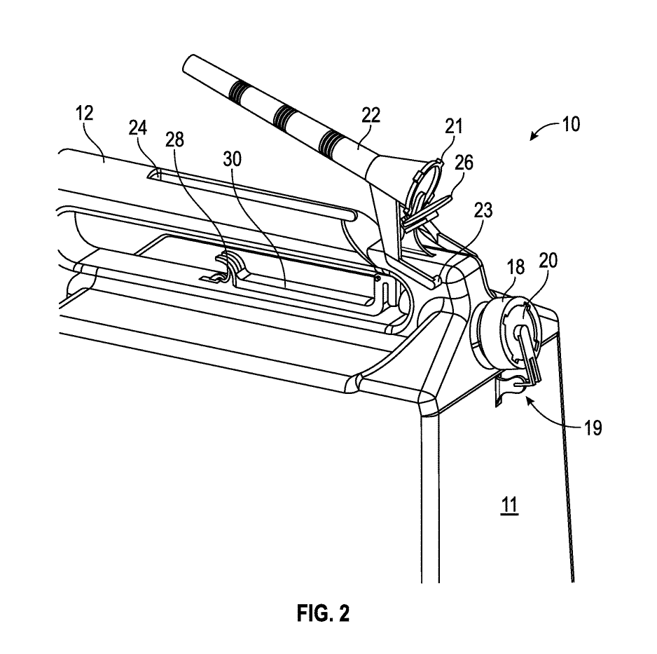

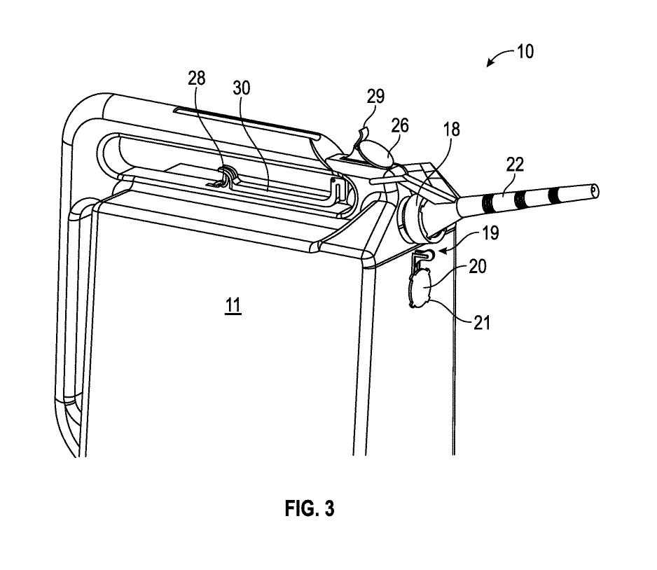

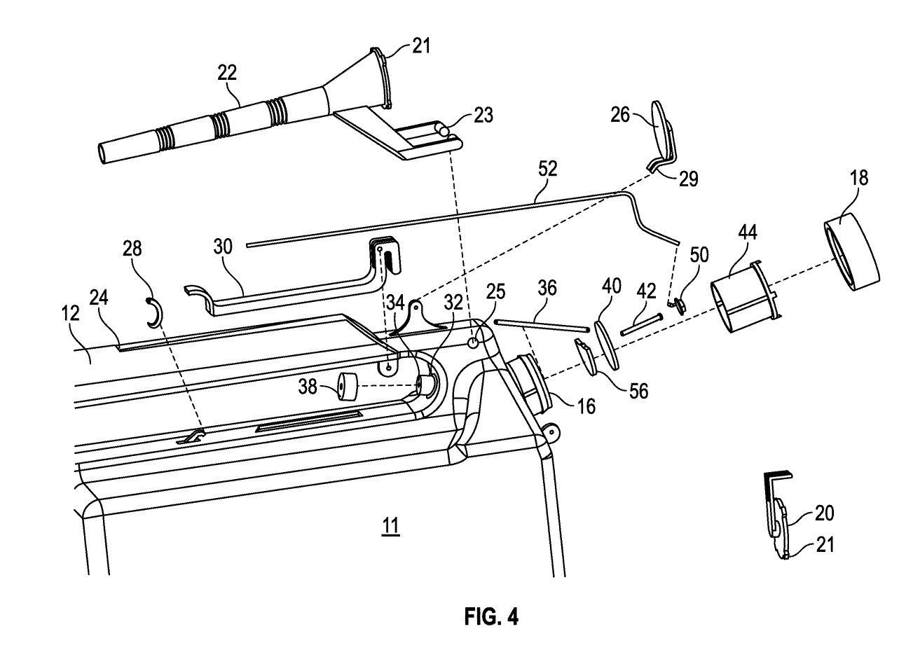

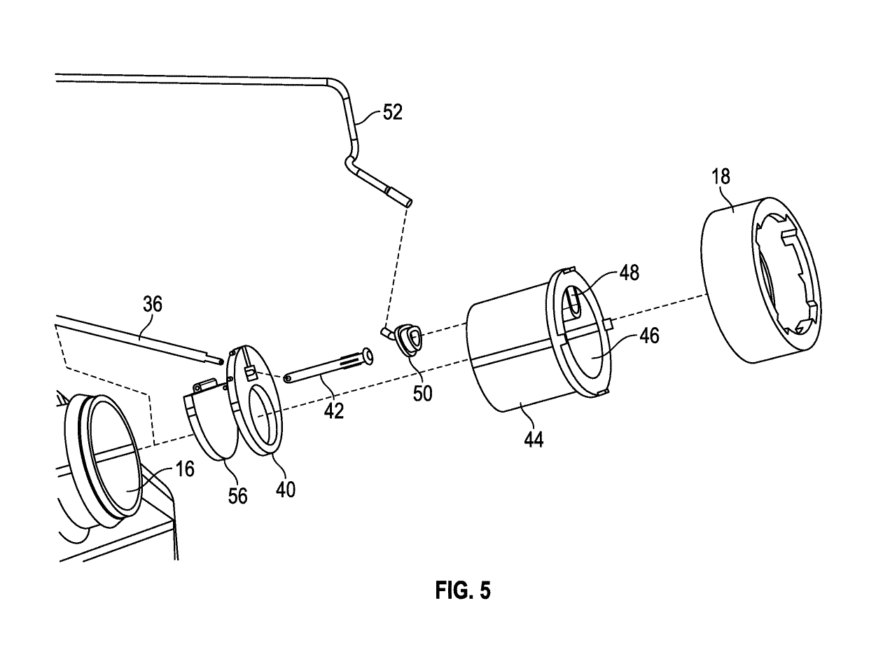

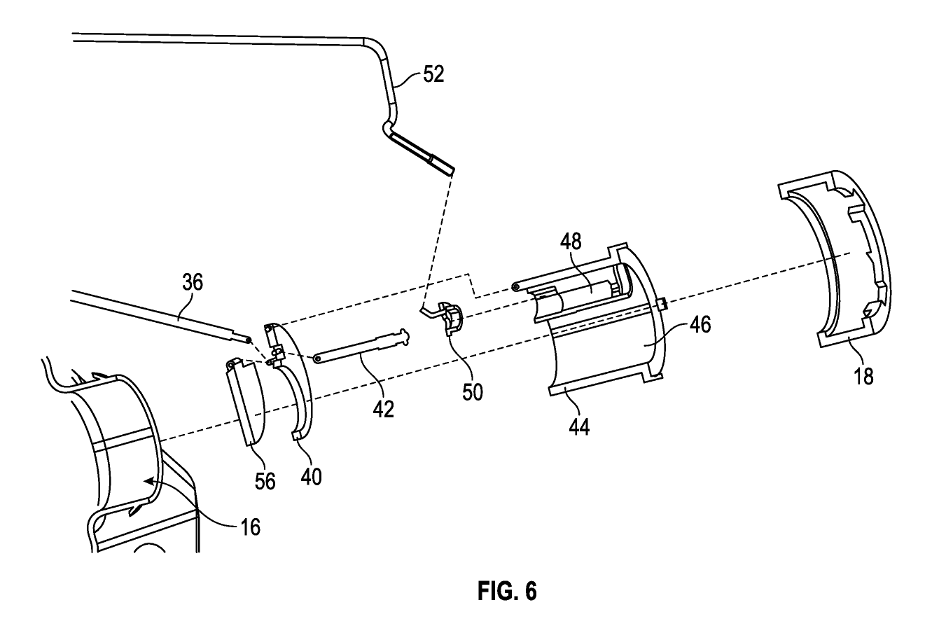

### DETAILED DESCRIPTION OF THE INVENTION

As used herein, “a” or “an” or “the” means one or more unless the context clearly dictates otherwise.

As used herein, the term “mechanical advantage” is intended to mean force amplification. An example of such mechanical advantage is when a lever is pivotally connected at a first end and a force that is perpendicular to the primary axis of the lever is applied at a second end and the mechanical advantage is provided to a point along the lever between the first and the second ends.

Referring now to the figures, in one embodiment, self-venting container 10 preferably includes vessel 11 with handle 12, which is most preferably disposed on a top portion of container 10. Although not essential for the operation of the present invention, in one embodiment, one or more additional handles 14 can optionally be disposed on other locations on or about container 10—including but not limited to a rear side of container 10. Although vessel 11 can be formed from any desired material by any known process of manufacture, in one embodiment, vessel 11 is preferably formed from high-density polyethylene (“HDPE”) in a blow-molding process. Various other components of self-venting container 10 can also be formed from HDPE, most preferably via an injection molding process.

Although vessel 11 can be made to virtually any size desired, in one embodiment, vessel 11 preferably comprises a capacity of from about ½ gallon to about 10 gallons and more preferably of from about 1 gallon to about 6 gallons.

Vessel 11 preferably comprises opening 16. Opening 16 is most preferably disposed in vessel 11 near a top portion thereof.

Coupler 18 is most preferably a rotatable coupler and most preferably comprises a configuration that can be completely activated and deactivated by a partial rotation—for example, via a quarter of a turn. In one embodiment, coupler can be activated by turning it a partial turn in a clockwise direction and can be deactivated by turning it a partial turn in a counter-clockwise direction. Coupler 18 can be a twist-lock coupler which receives tabs 21 that can optionally be disposed on spout 22 and/or lid 20.

Hinge connection 19 is preferably used to connect lid 20 to vessel 11. Coupler 18 can preferably secure lid 20 over opening 16 of vessel 11. When lid 20 is not in use, it is preferably swung down below opening 20 so that spout 22 can be rotated via pins 23 in opening 25, which are preferably disposed on opposing sides of container 10. Of course, other hinge connections can be used and will provide desirable results. For example, in one embodiment, pins 23 can instead be formed into openings and instead of forming openings 25 into the sides of container 10, pegs can instead be positioned there. As with lid 20, tabs 21 are preferably disposed around an inlet (i.e. a proximal end) of spout 22 such that spout 22 can be secured over opening 16 by coupler 18. In one embodiment, a recess can be formed into handle 12 such that spout 22 can be stowed thereon. Handle 12 is preferably formed such that when spout 22 is in a stowed position, cap 24 is disposed over an outlet of spout 22. Cap 24, which can optionally be nothing more than a portion of handle 12, thus prevents the entry of debris into the outlet of spout 22 when it is stowed on or in handle 12. In one embodiment, cap 24 is preferably positioned such that it forms an interference fit with the outlet end portion of spout 22, thus retaining spout 22 in a stowed configuration until a user pulls on spout 22 with sufficient force to overcome the strength of the interference fit.

Dust cover 26 is preferably provided to cover and protect an inlet in spout 22 when it is stowed in a stored configuration in handle 12. Dust cover 26 is preferably hingedly connected to container 10 via hinge 27. Dust cover 26 also preferably comprises lever 29. When spout 22 is rotated up into its stowed position, an inlet of spout 22 preferably makes contact with lever 29 and as spout 22 continues to rotate into its stowed position, lever 29 and thus dust cover 26 are thus rotated about hinge 27. Once spout 22 is in its fully-stowed position, dust cover 26 is preferably pressed against an inlet of spout 22 such that the inlet is covered. When spout 22 is removed from its stowed position, it preferably relieves pressure from lever 29 as the inlet portion of spout 22 forces dust cover 26 out of its way. Because hinge 27 is preferably not located in the same location as the hinge formed by pins 23 and openings 25, spout 22 is able to travel past dust cover 26 such that it becomes clear of the movement of spout 22. Spout 22 can thus continue to rotate into operational position, aligning with a coupler 18, such that coupler 18 can receive and secure an inlet end portion of spout 22—most preferably by receiving tabs 21 which are preferably formed around the inlet of spout 22.

Once spout 22 has been secured into its operational position with its inlet disposed over opening 16 of vessel 11, and coupler 18 has secured spout 22 in place, safety latch 28, which can optionally be provided, can be released, thus allowing trigger 30 to be engaged. Safety latch preferably prevents trigger 30 from being activated unless safety latch 28 has been overcome first. Although trigger 30 is illustrated as having a lever-type configuration in the drawings, any shape of trigger 30 can be used so long as it can operate at least some of the components described below.

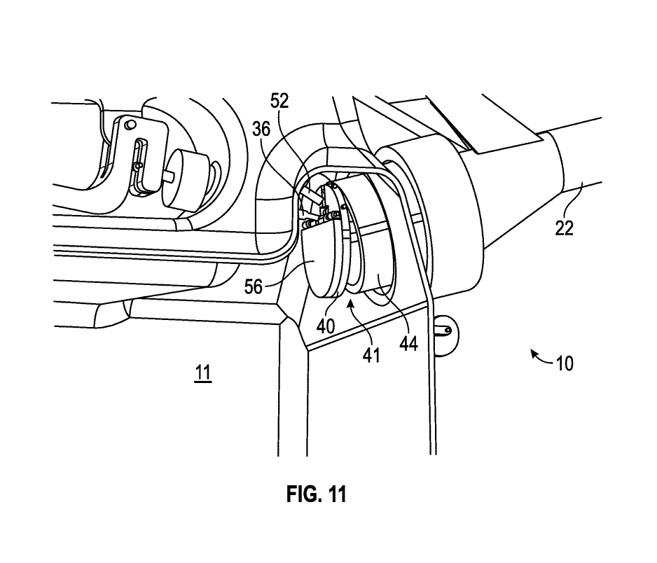

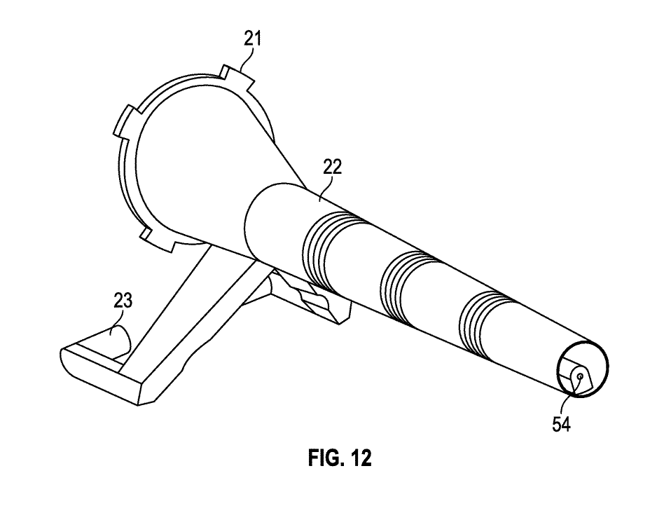

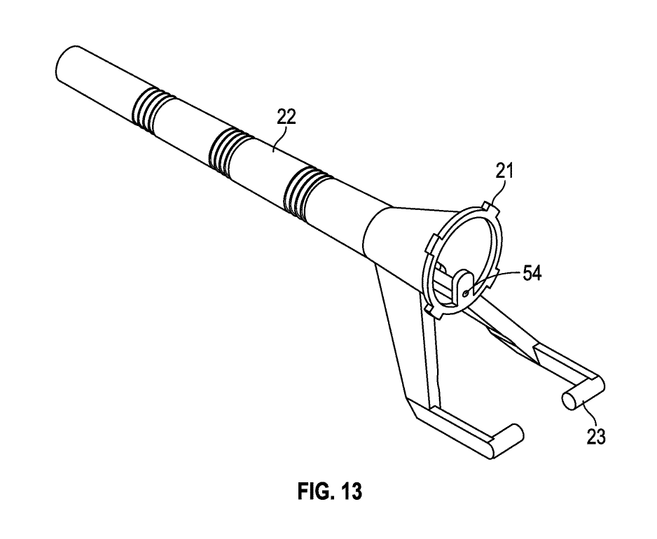

Nipple 32 is preferably disposed near trigger 30 and has opening 34, therein through which linkage rod 36 passes to penetrate into vessel 11. Cap 38 is preferably disposed on nipple 32 to create a seal around 36 at nipple opening 34. In one embodiment, seals, which can include any apparatus or structure that can form a liquid-tight connection around a translating rod can be disposed on or in cap 38 or nipple 32 to prevent any liquid from escaping from vessel 11 by leaking around rod 36. When a user actuates trigger 30, it preferably pulls linkage rod 36, thus opening discharge valve 40 so that when vessel 11 is rotated, liquid disposed therein can escape through opening 41 (see FIG. 11) that is formed between discharge valve 40 and housing 44, thus permitting the liquid within vessel 11 to be discharged out of opening 16 through discharge opening 46 in housing 44, and through spout 22 (if spout 22 is disposed in its operational configuration). Vent valve 42 is preferably linked to discharge valve 40, thus allowing simultaneous operation of both valves.

In one embodiment, discharge valve 40 is preferably a flap or plate which presses against the back of housing 44. Optionally, a gasket can be attached a front face of discharge valve 40 or the back of housing 44 to provide a liquid-tight seal between discharge valve 40 and housing 44 when discharge valve 40 is closed; or the gasket can be disposed between discharge valve 40 and housing 44. In one embodiment, opening 43 is preferably provided through discharge valve 40.

Housing 44 also preferably comprises vent valve housing 48 which most preferably houses, and provides a seat for, vent valve 42. Valve guide 50 is preferably disposed in a proximal end portion of vent valve housing 48 to stabilize movement of vent valve 42. Intake channel 52 is preferably communicably coupled to valve guide 50 and has its terminal end disposed within vessel 11, most preferably at a location that is typically above a surface of a liquid disposed in vessel 11 when container 10 is held in a position for discharging its liquid contents. Vent valve housing 48 preferably aligns with vent channel 54 of spout 22, thus allowing container 10 to be self-venting.

In order to fill vessel 11 with liquid when lid 20 is covering opening 16, coupler 18 is preferably rotated to release lid 20. Lid 20 is then rotated down and out of the way, thus exposing opening 16 through discharge opening 46. A filling nozzle, including but not limited to a fuel pump discharge nozzle is then pushed through discharge opening 46, through opening 43 in discharge valve 40. The filling nozzle then preferably presses against check valve 56 and forces it open such that the terminal end portion of the filling nozzle is within vessel 11. In one embodiment, check valve 56 is preferably spring-loaded such that it remains in a closed configuration until a filling nozzle or some other object presses against it with sufficient force to force it open.

In one embodiment, check valve 56 is preferably a flap-type valve that presses against a back portion of discharge valve, thus closing off opening 43 in discharge valve 40. Optionally, a gasket can be disposed between discharge valve 40 and check valve 56 to provide a liquid-tight seal until sufficient force is exerted against check valve 56 to force it open.

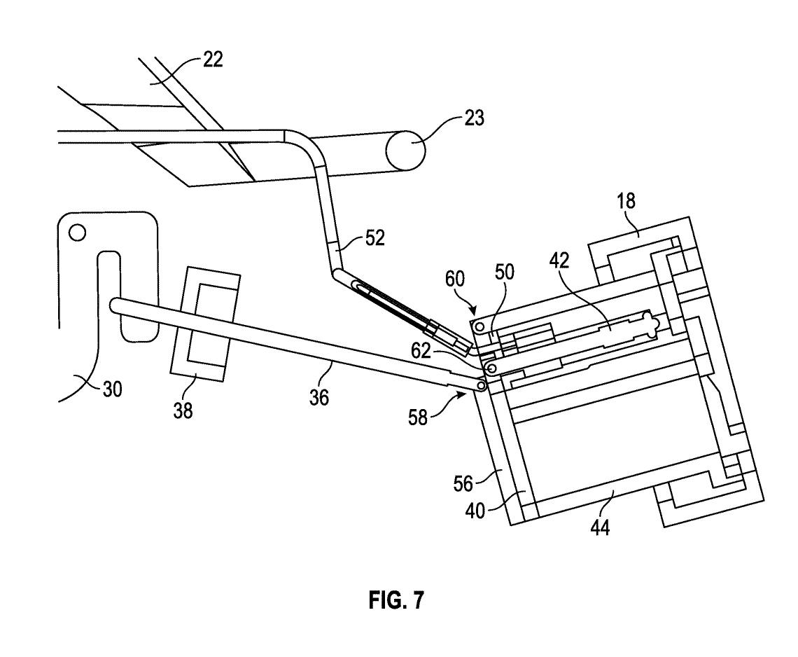

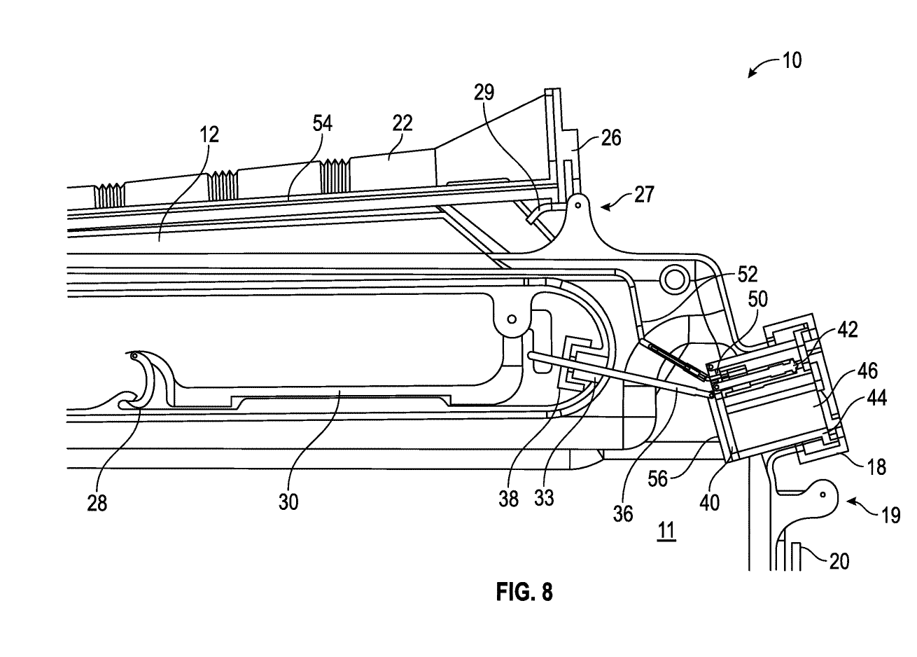

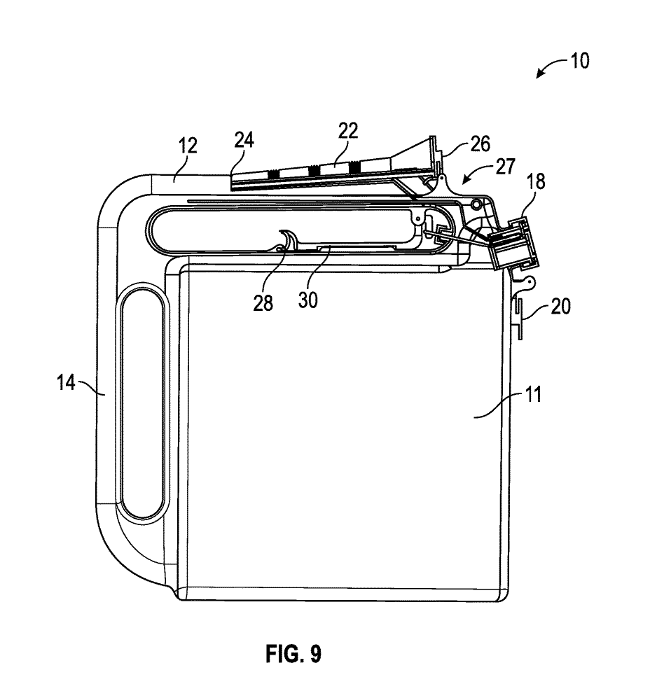

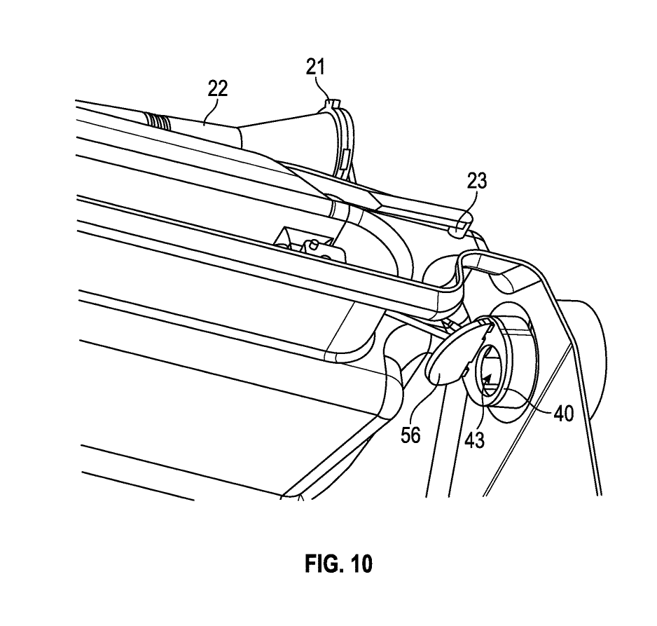

In one embodiment, rod 36 preferably connects to a proximal side of discharge valve 40 via pivot connection 58 (see FIG. 7), which is also the location at which a top portion of check valve 56 connects to discharge valve 40. Discharge valve 40 is preferably connected at its top portion to housing 40 via hinge connection 60. Vent valve 42 is preferably connected to discharge valve 40 by pivot connection 62, which is most preferably disposed at a location between hinge pivot connection 58 and hinge connection 60. This therefore results in a mechanical advantage being created by rod 36 pulling on valve 40 at a distance further away from hinge 60 than is pivot connection 62. In this embodiment, when rod 36 is pulled by handle 30, both discharge valve 40 and check valve 56 remain together and swing away from a lower portion of housing 44 while a top portion of check valve 40 and housing 44 remain connected together at hinge 60. As discharge valve 40 is drawn back, pivot connection 62 is also drawn back, thereby pulling vent valve 42 open.

An embodiment of self-venting container 10 is preferably configured to be user friendly such that it is quick to un-stow and stow, discharges liquid at an acceptable rate, and is safe. With that in mind, when spout 22 is stowed in handle 12, the shape of handle 12 with spout 22 together preferably form a shape which is comfortable for handling and carrying.

Each of valves 40, 42 and 56 are preferably closed liquid-tight when trigger 30 is not actuated—thus preventing any incidental spillage during any transportation and/or before user is ready to dispense the contents of container 10. Safety latch 28 prevents any premature or accidental operation of trigger 30.

In one embodiment, a user may place container 10 into the pouring position, while grasping both handles 12 and 14, slide a finger from the rear of vessel 11 to the front, thus releasing safety latch 28. To initiate a flow of liquid from vessel 11, a user can actuate trigger 30, thereby opening discharge valve 40 and vent valve 42. The flow rate of liquid being dispensed can be controllable by how much the user actuates trigger 30. Actuating trigger 30 in the pouring position with liquid disposed in vessel 11 preferably causes the liquid to flow through discharge opening 46 and through spout 22 into a receiving container or tank. Vessel 11 is preferably vented by replacing the volume of dispensed liquid with air and/or vapors from the receiving container/tank by drawing them through a terminal end (i.e. inlet) of vent channel 54 of spout 22, past vent valve 42, and through intake channel 52—most preferably to a rear of vessel 11, above the liquid line, thus eliminating the impeding pressure of the liquid as resistance to venting and to prevent the “glug-glug” effect so as to maintain a consistent flow.

The user can release trigger 30 at any time, which will immediately stop flow of liquid out of vessel 11, by causing discharge valve 40 to close and seal concurrently with the closing of vent valve 42. When the user completely releases trigger 30 it preferably returns back to its locked position and is again secured by safety latch 28. Now that the user is finished, spout 22 can easily be uncoupled, for example by rotating coupler 18 counterclockwise a quarter of a turn. Spout 22 can then be returned to its stowed position. Spout 22 preferably recesses into handle 12 and is covered by cap 24. During the stowing process of spout 22, dust cover 26 is mechanically levered into place by the base of spout 22 acting against lever 29, thereby preventing dust and debris from entering and protecting the inlet opening (i.e. the proximal opening) in spout 22. Lid 20 can be rotated into its closed position and locked in place with coupler 18, thus preventing dust and debris from entering vessel 11.

In one embodiment, the only time that any liquid can exit vessel 11 is either when the user is actuating trigger 22, or when the user is actively filling vessel 11 through check valve 56. Thus resulting in a container that, aside from operator error, is spill proof. In one embodiment, a flame arrestor, which can optionally include a metal screen, can be disposed in communication with opening 16. In one embodiment, only one opening 16 is provided for both discharging a liquid and venting gas into vessel 11, while a second opening is provided through which linkage rod 36 passes. However, desirable results can still be achieved when a plurality of openings are provided in vessel 11 for both discharging liquid and venting gas into vessel 11. In one embodiment, a pressure-relief valve can be provided—most preferably one which is communicably coupled to an upper portion of vessel 11. Optionally, vent valve 42 can be arranged such that it can also function as a pressure-relief valve. In one embodiment, instead of intake channel 52 comprising a tube which extends from vent valve 42, intake channel 52 can instead be formed or otherwise disposed in handle 12, which itself can optionally comprise a hollow tube-like structure.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

What is claimed is:

1. A portable liquid delivery apparatus comprising:
a liquid storage vessel, said liquid storage vessel comprising only one opening for both discharging liquid from said liquid storage vessel and for venting gas into said liquid storage vessel;
a liquid discharge valve; and
a check valve, said check valve forming a portion of said discharge valve.

2. The portable liquid delivery apparatus of claim 1 wherein said opening is at or near a top of said vessel.

3. The portable liquid delivery apparatus of claim 1 wherein said check valve comprises dimensions sufficiently large to permit a standard fuel pump nozzle to pass through it.

4. The portable liquid delivery apparatus of claim 1 further comprising a vent valve.

5. The portable liquid delivery apparatus of claim 4 wherein said vent valve is communicably coupled to said liquid discharge valve.

6. The portable liquid delivery apparatus of claim 5 wherein said vent valve is connected to said liquid discharge valve via a connection that provides mechanical advantage.

7. The portable liquid delivery apparatus of claim 1 further comprising a spout, said spout hingedly connected such that it can rotate to align with said opening of said liquid storage vessel.

8. The portable liquid delivery apparatus of claim 7 further comprising a handle, said handle comprising an opening having dimensions which create an interference fit with an outside of said spout.

9. A portable liquid delivery apparatus comprising:
a liquid storage vessel;
a liquid discharge valve; and
a vent valve, said vent valve communicably coupled to said liquid discharge valve via a connection that provides mechanical advantage.

10. The portable liquid delivery apparatus of claim 9 wherein said liquid storage vessel comprises only one opening for both discharging a liquid and venting a gas into said liquid storage vessel.

11. The portable liquid delivery apparatus of claim 9 further comprising a lid rotatably coupled to said portable liquid delivery apparatus.

12. A portable fuel container comprising:
a liquid storage vessel; and
a liquid discharge valve, said liquid discharge valve configured to receive a fuel pump nozzle, by allowing an end portion of the fuel pump nozzle to pass directly through said liquid discharge valve for filling said liquid storage vessel with fuel.

13. The portable fuel container of claim 12 wherein said portable fuel container further comprises a vent valve, said vent valve communicably coupled to said liquid discharge valve via a connection that provides mechanical advantage.

14. The portable fuel container of claim 12 further comprising a spout connected to said portable fuel container via a hinge.

15. The portable fuel container of claim 14 wherein said hinge is positioned such that an inlet of said spout aligns with an outlet of said liquid storage vessel when said spout is rotated into a use position.

16. The portable fuel container of claim 14 further comprising a spout storage recess formed into a handle of said portable fuel container.

17. The portable fuel container of claim 16 further comprising a spout inlet cover hingedly connected to said liquid storage vessel.

18. A portable fuel container comprising:
a liquid storage vessel having only two openings, a first of said only two openings comprising a translating passing there through with a liquid-tight seal around it, and a second of said only two openings for both dispensing liquid from the fuel container and for filling the fuel container from a standard fuel pump nozzle; and
a liquid discharge valve disposed in fluid communication with said second opening, wherein said liquid storage vessel can be filled from the standard fuel pump nozzle without requiring a user to remove said liquid discharge valve from the flow path of the fuel.

19. The portable fuel container of claim 18 wherein said second opening further comprises an intake inlet disposed therein.

20. The portable fuel container of claim 18 further comprising a check valve in fluid communication with said liquid discharge valve.

21. A portable liquid delivery apparatus comprising:
a liquid storage vessel comprising an opening;
a neck extending from said opening; and
a coupler disposed about said neck, said coupler comprising a rim on its front face, said rim comprising a plurality of tab-receiving openings formed therein.
